(19) United States
(12) Patent Application Publication
(10) Pub. No.: US 2006/0272895 A1
(43) Pub. Date: Dec. 7, 2006

(54) Detachable stairway system for water vehicles and method of use

(76) Inventor: Jeffrey Lavoie, Mooresville, NC (US)

Correspondence Address: DIEDERIKS & WHITELAW, PLC, 12471 Dillingham Square, #301, Woodbridge, VA, 22192, US

(21) Appl. No.: 11/141,408

(22) Filed: Jun. 1, 2005

(51) Int. Cl. E06C 5/00

(52) U.S. Cl. 182/127

(57) ABSTRACT

A detachable stairway system for use with a telescoping water vehicle ladder includes a frame, top and bottom brackets, and at least two steps hingedly mounted to the frame. Optionally, support cables and/or pneumatic cylinders can be added for support. A user attaches the stairway system to a ladder by hooking the bottom bracket under a bottom rung of the ladder, lifting the stairway system, and hooking the top bracket over a top rung of the ladder. Hooks may be utilized to more fully secure the stairway system to the ladder. The telescoping nature of the ladder allows it to expand/contract during attachment of the stairway system and to fully support and stabilize the stairway system to provide a safe and easy way to enter/exit a water vehicle. The hinged nature of the steps allows the stairway system to be folded for stowing/storage.

### BACKGROUND OF THE INVENTION

1. Field of the Invention

The present invention pertains to a detachable stairway system for water vehicles and method of use thereof. More specifically, the invention pertains to a stairway system that can be detachably mounted on a telescoping ladder, such as a boat ladder.

2. Discussion of the Prior Art

A variety of stepping structures have been commonly used to aid in ingress and egress from a vehicle. For example, U.S. Pat. No. 3,067,835 discloses collapsible metal steps that bolt to a vehicle. With regards to water vehicles, such as boats, ladders are typically used to enter or exit the vehicle. Boats often come equipped with a retractable or telescoping type ladder, such as the one disclosed in U.S. Pat. No. 3,774,720. These types of boat ladders are difficult to use for certain individuals, especially the elderly or handicapped. Additionally, dogs might have a difficult time getting into and out of a boat having such a ladder, especially from the water.

One proposed solution is to provide a stairway system for a boat. Such systems include those designed for attachment to the rear of the water vehicle or for hooking over the edge of a boat as demonstrated by U.S. Pat. Nos. 5,887,540 and Des. 243,854. Most boats come equipped with a standard ladder, and additional costs may be incurred if a user desires to replace the existing ladder with such a stairway system. Furthermore, such stairways are cumbersome and difficult to store when not in use.

Water vehicles are constantly in motion in the water, therefore it is important to provide a system for getting into and out of the vehicle that can be safely secured to the boat while the boat is stationary or removed for storage while the boat is in motion. As typical boat ladders are not adequate for some users, there is a need in the art to provide a detachable stairway system for safely and easily entering and exiting a boat that can be used with an existing boat ladder, stored away when not in use and be completely removed when the boat is going to be in motion.

### SUMMARY OF THE INVENTION

The present invention is directed to a detachable stairway system for use with a water vehicle. The stairway system includes a frame with a handle portion, top and bottom brackets extending from the frame, and at least two steps hingedly mounted to the frame. Optionally, support cables and/or pneumatic cylinders can be added to the stairway system to increase the load capacity of the system and provide additional stability.

In order to attach the stairway system to a telescoping water vehicle ladder, a user hooks the bottom bracket under a bottom rung of the ladder, lifts the stairway system with the aid of the handle portion, and hooks the top bracket over a top rung of the ladder. As the stairway system is lifted, after hooking the bottom bracket under the bottom ladder rung, the telescoping nature of the ladder allows it to retract/compact part way. Likewise, as the top bracket is lowered over the top ladder rung the telescoping nature of the ladder allows it extend part way. In this manner, the lower ladder rung is held by the bottom bracket and the top ladder rung is held by the top bracket, such that the stairway system is stabilized by the ladder and provides a safe and easy way to enter or exit the water vehicle. Additionally, hooks located at the top of the frame may be hooked over top portions of the ladder or may be inserted into the upper tube members of the ladder to more fully secure the stairway system to the ladder. While still on the ladder, the stairway system can be folded into a stowed position.

In order to remove the stairway system from the ladder, a user simply lifts the top bracket off the top rung (thus simultaneously lifting the hooks off the top portions of the ladder), and lowers the stairway system until the bottom rung is clear of the bottom bracket. The stairway system may then be folded for storage.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a side perspective view of a detachable stairway system to be installed on a telescoping boat ladder;

FIG. 2 is a side view of the detachable stairway system of FIG. 1 installed on a telescoping boat ladder; and

FIG. 3 is a side view of the detachable stairway system of FIG. 1 folded into a stowing/storage position.

### DETAILED DESCRIPTION OF THE PREFERRED EMBODIMENT

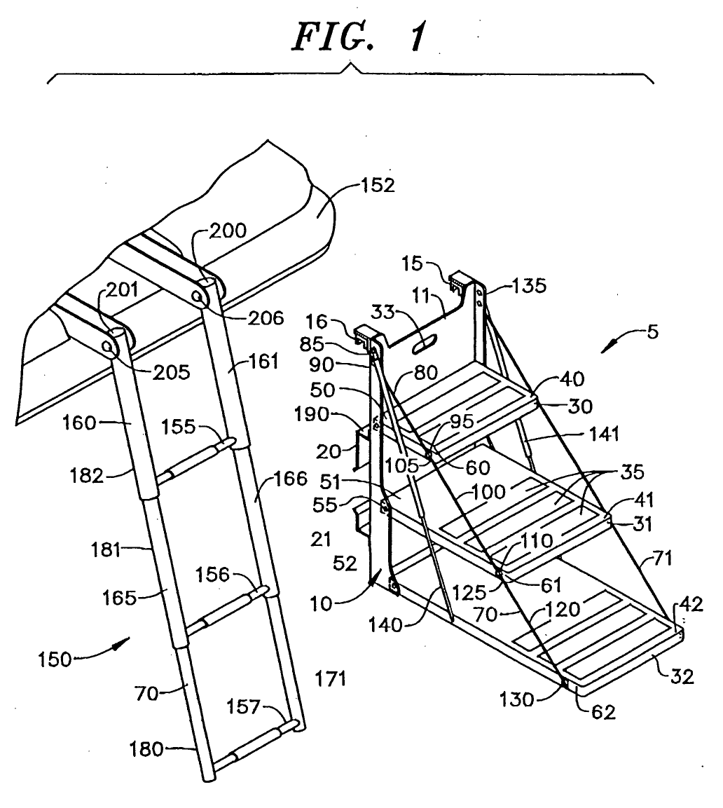

With initial reference to FIG. 1, a detachable stairway system 5 (hereafter stairway system 5) includes: a frame 10 having a back plate 11; top hooks 15 and 16; first and second or top and bottom brackets 20 and 21 extending from frame 10; and an upper step, a first lower step and a second lower step, or top, middle and bottom steps 30-32 hingedly connected to frame 10. Back plate 11 includes a cut-out of handle portion 33. Bottom step 32 has a length greater than that of middle step 31 and middle step 31 has a length greater than that of top step 30, such that the positioning of one step above another provides a “stairway” upon which a user can walk. A plurality of slip resistant strips 35 are fixed to surface portions 40, 41, and 42 of respective steps 30, 31, and 32.

In a preferred embodiment, frame 10 and steps 30-32 are made of aluminum. Although shown in FIGS. 1-3 as solid sheets of aluminum, steps 30-32 can be made from metal lattice, stainless steel sheet or formed from plastic or any other durable material. If steps 30-32 are formed from metal lattice, or some other material, the material itself can include slip resistant structure, and the addition of slip resistant strips 35 may not be necessary. Steps 30-32 each include respective end portions 50-52 that are each hingedly attached to frame 10, such as through bolts 55. In a preferred embodiment, steps 30-32 also include respective front portions 60-62 which are attached to support cables 70 and 71. More specifically, cable 70 has a top section 80 with a first end 85 attached to a top end 90 of frame 10, and a second end 95 attached to front portion 60 of step 30. A middle section 100 of support cable 70 has a first end 105 attached to front portion 60 of step 30, and a second end 110 attached to front portion 61 of step 31. A bottom section 120 of support cable 70 has a first end 125 attached to front portion 61 of step 31 and a second end 130 attached to front portion 62 of step 32. Support cable 71 is a mirror image of support cable 70 and is attached to a top end 135 of frame 10 and front portions 60-62 of steps 30-32 in a like manner. Support cables 70, 71 add stability and strength to stairway system 5, and allow steps 30-32 to support more weight than would otherwise be possible. Optionally, pneumatic cylinders 140,141 may be attached to and extend between respective top ends 90,135 of frame 10 and step 32 so as to add additional support and stabilization to stairway system 5. Support cables 70,71 can be in the form of wire cables, chains, ropes, or any other equivalent flexible support. Although depicted with two support cables (70,71) in FIG. 1, stairway system 5 could have any number of support cables, or non at all, depending on the desired load-bearing capacity of stairway system 5.

Although any boat ladder having two or more rungs can be used with the present stairway system 5, a telescoping boat ladder 150 (hereafter ladder 150) attached to a boat platform 152, having an upper rung, a first lower rung and a second lower rung, or top, middle and bottom rungs 155-157 will be referenced herein when describing the preferred embodiment of the present invention. As shown in FIG. 1, top rung 155 of ladder 150 is attached to upper tube members 160,161; middle rung 156 is attached to middle tube members 165,166; and lower or bottom rung 157 is attached to bottom tube members 170,171. Bottom tube members 170 and 171 engage middle tube members 165 and 166, respectively, and middle tube members 165 and 166 engage upper tube members 160 and 161, respectively, such that middle and bottom sections 180 and 181 can telescope longitudinally in relation to upper section 182 from an extended ingress/egress position, to a retracted or stowed position.

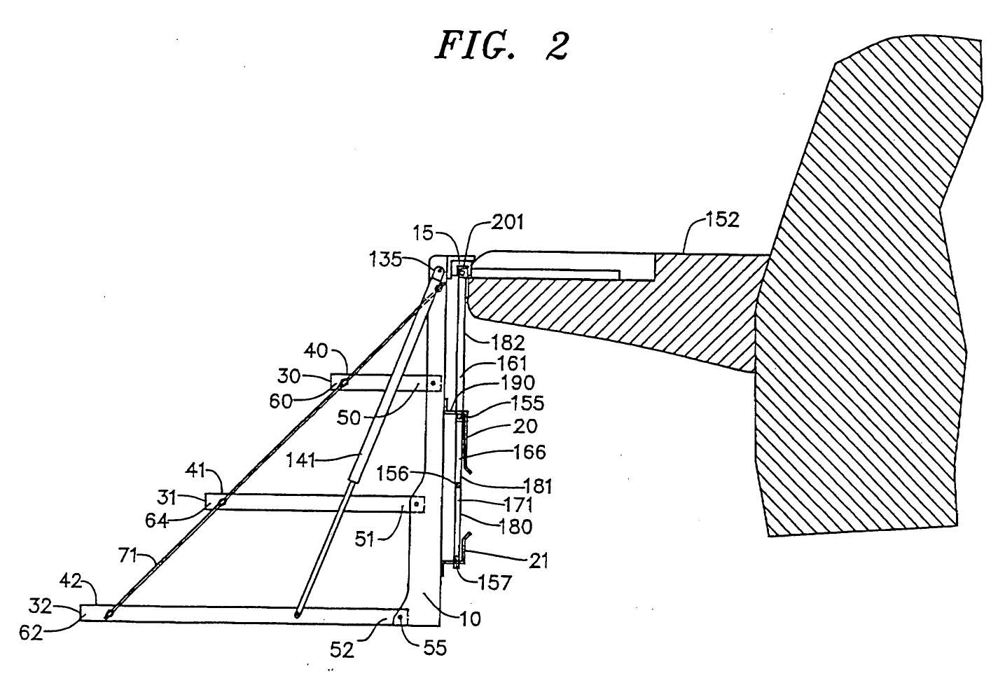

At this point, FIGS. 1 and 2 will be referenced for the manner in which a user can attach stairway system 5 to ladder 150 when the ladder is in an extended or usable position. Initially, a user hooks bottom bracket 21 of stairway system 5 under bottom rung 157 of ladder 150. Next, with the aid of handle portion 33, the user lifts stairway system 5 1o and hooks top bracket 20 over top rung 155 of ladder 150. Preferably, top bracket 20 and bottom bracket 21 are somewhat flexible, such that top bracket 20 clips over and retains top rung 155 and bottom bracket 21 clips over and retains bottom rung 157. As stairway system 5 is lifted, bottom bracket 21 simultaneously lifts bottom rung 157 such that middle and bottom ladder sections 180 and 181 retract part way. Once top bracket 20 is hooked over top rung 155, stairway system 5 can be lowered until support portion 190 of top bracket 20 abuts and is supported by top rung 155. As stairway system 5 is lowered, bottom rung 157 is lowered somewhat such that middle and bottom ladder sections 180 and 181 extend/expand part way. In this manner, middle and bottom tube members (165,166;170,171) extend between top bracket 20 and bottom bracket 21 and, in conjunction with middle and bottom rungs 156 and 157, help stabilize stairway system 5.

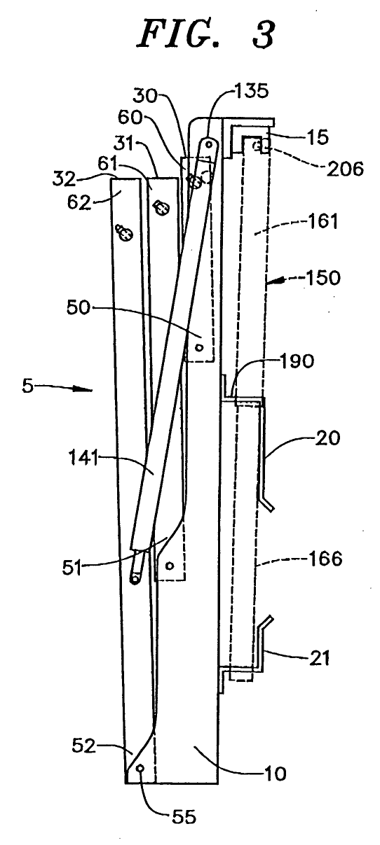

In a preferred embodiment, additional stabilization is provided to stairway system 5 by top hooks 15,16, which hook over respective top portions 200,201 of upper tube members 160,161. Top portions 200 and 201 can be in the form of removable plastic caps that seal off respective openings in upper tube member 160 and 161. In one embodiment shown in FIG. 3, top portions 200 and 201 are removed and top hooks 15 and 16 are inserted into respective openings in tube members 160,161 instead of being hooked over top portions 200, 201. Top hooks 15 and 16 can be inserted into respective tube members 106,161 such that they are on one side of respective bolts 205,206 which extend through respective upper tube members 160,161. To remove stairway system 5 from ladder 150, a user simply lifts top bracket 20 off of top rung 155 (thus simultaneously lifting top hooks 15 and 16 off of/out of respective top portions 200 and 201), and lowers stairway system 5 until bottom rung 157 is removed from bottom bracket 21.

Stairway system 5 can be extended to an ingress/egress position, as depicted in FIG. 2, or can be folded to a stowing/storage position as depicted in FIG. 3. In order to fold stairway system 5 into a stowed position, a user pivots top, middle and bottom steps 30-32 about respective bolts 55 until steps 30-32 and frame 10 are all substantially parallel to one another. This motion allows a user to fold stairway system 5 into a stowed position, in which stairway system 5 is still attached to ladder 150, or a storage position in the case that the stairway system 5 has been detached from ladder 150.

Although described with reference to a preferred embodiment of the invention, it should be readily understood that various changes and/or modifications can be made to the invention without departing from the spirit thereof. For instance, although depicted as having three steps, it is understood that stairway system 5 could have any desired number of steps. Furthermore, although a three runged ladder 150 is depicted for use with stairway system 5, any telescoping ladder having two or more rungs could be used in conjunction with stairway system 5 without departing from the spirit of the invention. In general, the invention is only intended to be limited by the scope of the following claims.

I claim:

1. A detachable stairway system for a water vehicle including a water vehicle ladder with an upper rung and a lower rung, said stairway system comprising:
a frame member;
an upper step having a length and an end portion hingedly mounted to said frame member;
a lower step having a length that is greater than the length of the top step, and an end portion hingedly mounted to said frame member;
a first bracket extending from the frame member; and
a second bracket extending from the frame member, wherein the second bracket is adapted to hook beneath the lower rung of the water vehicle ladder and the first bracket is adapted to hook over the lower rung of the water vehicle ladder such that the detachable stairway system can be supported by the water vehicle ladder in a stable manner.

2. The detachable stairway system of claim 1, wherein the detachable stairway system further comprises at least one support cable, the support cable being attached to the frame and to respective front portions of the upper and lower steps.

3. The detachable stairway system of claim 1, wherein the detachable stairway system further comprises at least one pneumatic cylinder attached to the frame and to one of the upper and lower steps.

4. The detachable stairway system of claim 1, wherein the detachable stairway system further comprises at least one top hook extending from the frame, the top hook being adapted to hook over a top portion of the water vehicle ladder.

5. The detachable stairway system of claim 1, wherein the detachable stairway system further comprises at least one top hook extending from the frame, the top hook being adapted to hook inside an upper tube member of the water vehicle ladder.

6. The detachable stairway system of claim 1, wherein the first bracket and second bracket are flexible and are adapted to clip over the upper and lower rungs of the water vehicle ladder.

7. The detachable stairway system of claim 1, wherein the frame further includes a back plate having a handle portion formed therein.

8. In a water vehicle having a water vehicle ladder including an upper rung and a lower rung, a detachable stairway system comprising:
a frame member;
an upper step having a length and an end portion hingedly mounted to said frame member;
a lower step having a length that is greater than the length of the upper step, and an end portion hingedly mounted to said frame member;
a first bracket extending from the frame member; and
a second bracket extending from the frame member, wherein the second bracket is adapted to hook beneath the lower rung of the water vehicle ladder and the first bracket is adapted to hook over the upper rung of the water vehicle ladder such that the detachable stairway system can be supported by the water vehicle ladder in a stable manner.

9. The detachable stairway system of claim 8, wherein the detachable stairway system further comprises at least one support cable, the support cable being attached to the frame and to respective front portions of the upper and lower steps.

10. The detachable stairway system of claim 8, wherein the detachable stairway system further comprises at least one pneumatic cylinder attached to the frame and to one of the upper and lower steps.

11. The detachable stairway system of claim 8, wherein the detachable stairway system further comprises at least one top hook extending from the frame, the top hook being adapted to hook over a top portion of the water vehicle ladder.

12. The detachable stairway system of claim 8, wherein the detachable stairway system further comprises at least one top hook extending from the frame, the top hook being adapted to hook inside an upper tube member of the water vehicle ladder.

13. The detachable stairway system of claim 8, wherein the first bracket and second bracket are flexible and are adapted to clip over the upper and lower rungs of the water vehicle ladder.

14. The detachable stairway system of claim 8, wherein the frame further includes a back plate having a handle portion formed therein.

15. A method of detachably mounting a stairway system including a frame, first and second brackets extending from the frame, and upper and lower steps hingedly attached to the frame, to a telescoping ladder including an upper rung and a lower rung, said method comprising:
hooking the second bracket of the stairway system under the lower rung of the telescoping ladder;
hooking the first bracket of the stairway system over the upper rung of the telescoping ladder; and
extending the telescoping ladder so that a support portion of the first bracket is supported by the upper rung of the telescoping ladder and the second bracket remains hooked to the lower rung.

16. The method of claim 15, wherein the method further comprising the step of hooking a top hook extending from the stairway system frame over a top portion of the telescoping ladder.

17. The method of claim 15, wherein the method further comprising the step of hooking a top hook extending from the stairway system frame inside an upper tube member of the telescoping ladder.

18. The method of claim 15, wherein hooking the second bracket of the stairway system under the lower rung of the telescoping ladder includes clipping the second bracket on the lower rung.

19. The method of claim 15, wherein the step of hooking the first bracket of the stairway system over the upper rung of the telescoping ladder includes clipping the first bracket on the upper rung.
